(19) United States
(12) Patent Application Publication
(10) Pub. No.: US 2011/0223673 A1
(43) Pub. Date: Sep. 15, 2011

(54) Polarized Optics for Optical Diagnostic Device

(75) Inventor: James A. Profitt, Goshen, IN (US)

(73) Assignee: SIEMENS HEALTHCARE DIAGNOSTICS INC., Tarrytown, NY (US)

(21) Appl. No.: 13/129,937

(22) PCT Filed: Nov. 16, 2009
(86) PCT No.: PCT/US09/64502

§ 371 Date: May 18, 2011

Related U.S. Application Data
(60) Provisional application No. 61/115,957, filed on Nov. 19, 2008.

(51) Int. Cl. G01N 21/00

(52) U.S. Cl. 436/8; 422/82.05; 436/164

(57) ABSTRACT

A readhead for a photometric diagnostic instrument includes a holder configured for receiving reagent sample media therein. The sample media has a plurality of test areas configured to react with, and change color, according to an amount of an analyte in a sample. The holder is sized and shaped for forming an indexed fit with the sample media. One or more light sources are configured to emit light onto the test areas. First and second polarized light filters are respectively disposed between the light sources and the test areas, and between the test areas and one or more light detectors, so that the light detectors receive diffuse, non-specular reflections of the light from the test areas, while substantially preventing the light detectors from receiving specular reflections of the light.

### BACKGROUND

1. Technical Field

The present invention generally relates to the field of clinical chemistry. More particularly, the present invention relates to a readhead for an optical diagnostic system that analyzes the color change associated with one or more test areas on sample media following contact thereof with a liquid specimen, such as urine or blood.

2. Background Information

Throughout this application, various patents are referred to by an identifying citation. The disclosures of the patents referenced in this application are hereby incorporated by reference into the present disclosure.

Sample media such as reagent test strips are widely used in the field of clinical chemistry. A test strip usually has one or more test areas spaced along the length thereof, with each test area being capable of undergoing a color change in response to contact with a liquid specimen. The liquid specimen usually contains one or more constituents or properties of interest. The presence and concentrations of these constituents or properties are determinable by an analysis of the color changes undergone by the test strip. Usually, this analysis involves a color comparison between the test area or test pad and a color standard or scale. In this way, reagent test strips assist physicians in diagnosing the existence of diseases and other health problems.

Color comparisons made with the naked eye can lead to imprecise measurement. Today, strip reading instruments exist that employ reflectance photometry for reading test strip color changes. These instruments, commonly known as photometers, are capable of measuring the light intensity changes resulting from color generating reactions. Included among photometers are spectrophotometers, which are capable of responding to more than one range of light wavelengths, e.g., colors. These instruments accurately determine the color change of a test strip within a particular wavelength range or bandwidth. Examples of such instruments include those sold under the CLINITEK trademark (e.g., the CLINITEK ATLAS®, the CLINITEK ADVANTUS®, and the CLINITEK STATUS®) by Siemens Healthcare Diagnostics, Inc. (Norwood, Mass.) and/or as disclosed in U.S. Pat. Nos. 5,408,535 and 5,877,863, both of which are fully incorporated by reference herein. These instruments are typically used to detect colors associated with a urine specimen on a MULTISTIX® (Siemens) reagent strip, or on relatively large reagent strip rolls for high volume automated analysis such as provided by the CLINITEK ATLAS® Automated Urine Chemistry Analyzer.

Another strip reading instrument utilizing reflectance photometry to read multiple test strips is disclosed in U.S. Pat. No. 5,055,261. An operator sequentially places test strips in a loading area. An arm orients the test strips on rails extending from the loading area to one or more reading stations employing readheads.

A common aspect of these instruments is that they utilize automated test pad transport systems, and tend to be installed at dedicated testing centers or laboratories, where samples are aggregated and tested in bulk.

In order to efficiently enable bulk illumination and reading of multiple test pads or test strips, it is often desirable to space the optical sensor sufficiently far from the test pads or strips, so that multiple pads are placed within the field of view of the detector. This approach advantageously enables multiple pads to be read at once, i.e., in bulk, rather than sequentially. This bulk detection avoids the need to properly sequence the detection, such as in the event of time sensitive reactions which must be read at specific time periods (e.g., 20 seconds for one, 50 seconds for another, 33 seconds for another). Placing all of the pads within the field of view of the sensor helps to ensure that images of all of the pads are capable of being captured at their optimal time periods.

A drawback of using this relatively large field of view, is that there is also a relatively great degree of opportunity for specular reflections from the light source to enter the field of view and obscure the image of the pad. Smaller devices, intended to measure a relatively small number of pads (e.g., a single strip or single test pad), may avoid much of this issue by permitting the detectors to have relatively small fields of view. These detectors may thus be placed close to the pads, with light sources placed at a relatively steep angle to the pad, so that most specular reflections are offset from the detector. See, for example U.S. patent application Ser. No. 11/158,634, entitled Miniature Optical Readhead for Optical Diagnostic Device filed on Jun. 22, 2005, by Juan F. Roman, (the “634 Application”), which is commonly assigned herewith and is fully incorporated herein by reference.

A need therefore exists for a diagnostic testing readhead and device that utilizes a relatively wide field of view to capture a single image of multiple test pads, to facilitate bulk reagent pad image detection while reducing the adverse effects of specular reflections from illumination sources.

### SUMMARY

An aspect of the present invention includes a readhead for a photometric diagnostic instrument, for illuminating a target area and detecting color information from the target area. The readhead includes a holder configured for receiving reagent sample media therein, the sample media having a plurality of test areas disposed in spaced relation thereon, each of the test areas configured to react with a sample when disposed in contact with the sample and to change color according to an amount of an analyte in the sample. One or more light sources are configured to emit light onto the test areas. One or more first polarized light filters having a first polarization direction are disposed optically between the light sources and the test areas, so that light reaching the test areas from the light sources is polarized in the first polarization direction. One or more light detectors are disposed to receive light reflected from the test areas. One or more second polarized light filters having a second polarization direction are disposed optically between the test areas and the light detectors. The first and second light filters are configured to enable said light detectors to receive diffuse, non-specular reflections of the light from the test areas when the sample media is indexed within said holder. The first and second light filters are also configured to substantially prevent said light detectors from receiving specular reflections of the light.

In another aspect of the invention, a photometric diagnostic instrument includes the readhead of the foregoing aspect, a processor operatively coupled to the light or color detectors and to the light sources, the processor configured to analyze the reflections received by the light or color detectors. The processor is configured to derive a diagnosis value from the analysis, and to generate an output corresponding thereto.

A further aspect of the invention includes a method for reading reagent sample media, the sample media having a plurality of test areas disposed in spaced relation thereon, each of the test areas configured to react with a sample when disposed in contact with the sample and to change color according to an amount of an analyte in the sample. The method includes receiving the sample media into a sample holder of a readhead of a photometric diagnostic device, and placing a polarization filter optically between the sample media and at least one of a light source and a light detector. Light is emitted onto the test areas, and diffuse, non-specular reflectances of the test areas are captured with the light detector. Specular reflections of the light are filtered, e.g., so as to reduce intensity before reaching the light or color detectors. The color of the non-specular reflectances is determined, to derive the amount of constituent or property in the sample. An output signal is then generated, which corresponds to the amount of the constituent or property.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a perspective view of an exemplary photometric diagnostic instrument which may be used to perform various tests of a body fluid sample disposed on reagent media, in accordance with an embodiment of the present invention;

FIG. 2 is a perspective, partially exploded view of reagent media and a reagent tray used with the instrument of FIG. 1;

FIG. 3 is a schematic view, on an enlarged scale, taken along 3-3 of FIG. 2, showing a field of view of an exemplary detector of a readhead embodiment which may be incorporated into the instrument of FIGS. 1 and 2, and having aspects of an alternate embodiment shown in phantom;

FIGS. 4A and 4B are front and side elevational views of an exemplary detector used in the embodiments of FIGS. 1-3;

FIG. 5 is a flow chart of operational aspects of embodiments of the present invention;

FIG. 6 is a flow chart of measurement steps effected during the operation of FIG. 5; and

FIGS. 7A and 7B are plan views of polarization filters usable with embodiments of the present invention; and

FIG. 8 is a view similar to that of FIG. 3, of portions of an alternate embodiment of the present invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

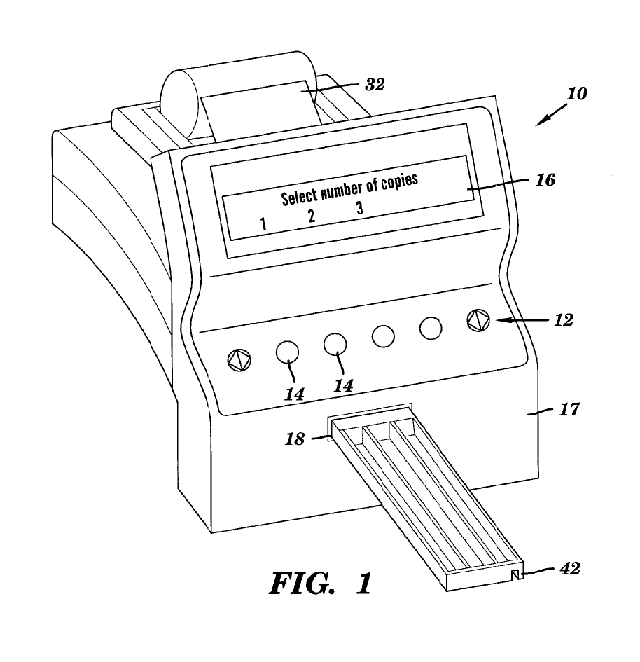

An overview of an embodiment of the invention is provided with reference to FIGS. 1-3.

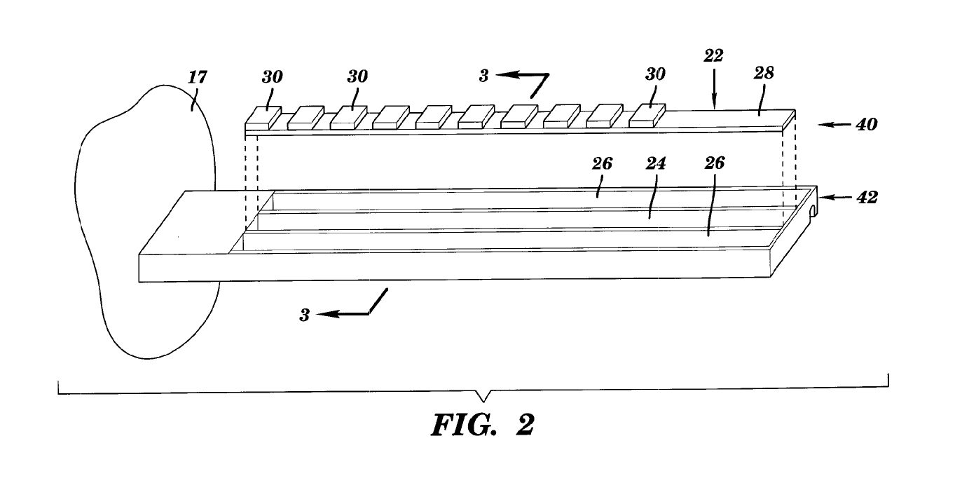

Turning to FIG. 1, a photometric diagnostic instrument (e.g., a reflectance spectrophotometer) 10 is configured for performing various tests, such as urinalysis tests, on sample media such as a reagent strip 40. As shown, this exemplary spectrophotometer 10 may be provided with an integral keyboard 11, including entry keys 14 that may be operated by a user. A visual display 16 may also be provided for displaying various messages relating to the operation of the spectrophotometer 10. As shown in both FIGS. 1 and 2, spectrophotometer 10 includes a front face 17 having an opening 18 formed therein, within which a tray (e.g., holder) 42 for carrying the reagent strip 40 may be retractably disposed. In the example shown, the tray 42 has channel 24, 26, sized and shaped to receive the reagent strip 40 therein. (It should be recognized that the instrument 10 is only but one of any number of instruments within which the various embodiments of the present invention may be employed.)

The reagent strip 40 has a thin, non-reactive substrate 28 on which a number of reagent test areas (e.g., pads) 30 are disposed. Each reagent pad 30 includes a relatively absorbent material impregnated with a respective reagent, each reagent and reagent pad 30 being associated with a particular test to be performed. When urinalysis tests are performed, they may include, for example, a test for leukocytes in the urine, a test of the pH of the urine, a test for blood in the urine, etc. When each reagent pad 30 comes into contact with a urine sample, the pad changes color over a time period, depending on the reagent used and the characteristics of the urine sample. The reagent test media 40 may be, for example, a Multistix® reagent commercially available from Siemens Healthcare Diagnostics, Inc.

To perform urinalysis testing, a urine sample is applied to the sample media 40, the media 40 is placed into the tray 42, and the tray 42 is automatically retracted into the spectrophotometer 10. The urine sample may be applied to media 40 either before or after retraction of the tray 42 into spectrophotometer 10.

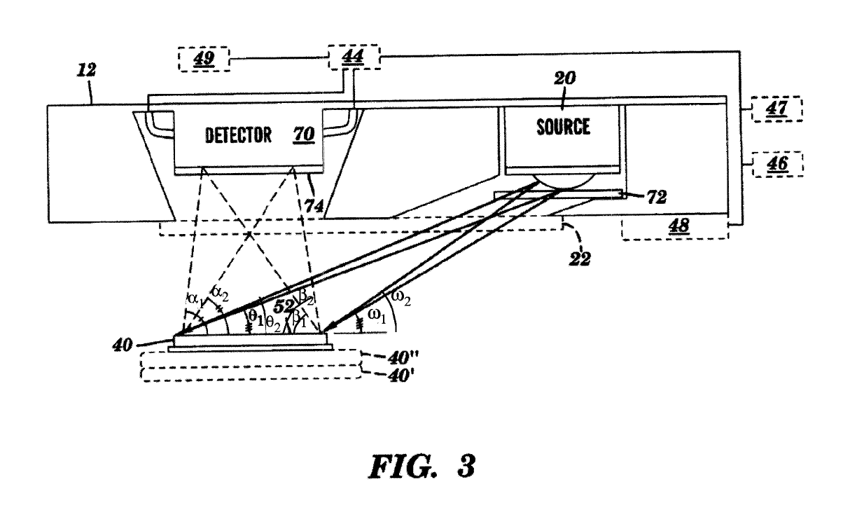

Turning now to FIG. 3, embodiments of the present invention include a readhead 12 that may be incorporated within a photometric diagnostic instrument such as instrument 10. The readhead 12 may thus be used to analyze reagent sample media, such as the above-referenced MULTISTIX® (Siemens) test strip. Readhead 12 includes a geometrical arrangement of light detector(s) or color detection means 70, and light source(s) 20. This embodiment also advantageously uses relatively inexpensive components, to enhance diffuse reflectance color detection, and inhibit capture of specular reflections. The embodiment thus allows improvement to the quality of analytical results by increasing the signal-to-noise ratio, in this case by increasing the diffuse to specular light ratio.

In this embodiment, readhead 12 includes one or more light sources 20 configured to illuminate the test areas (e.g., pads) 30 of the sample media (e.g., test strip) 40. The light source is superposed with a sample holder 42 (FIGS. 1, 2), which as discussed above, may be sized and shaped for forming an indexed fit with the sample media 40. A sensor (e.g., optical, mechanical, etc., (not shown)) may be used to check that the indexation is correct, e.g., to ensure that the strip has been properly position, such as upon retraction of the holder 42 into the instrument 10. One or more light or color detectors 70 is also disposed within readhead 12 to detect diffuse reflections from each of the test areas 30 when the sample media is indexed within holder 42. One or more first polarized light filters 72 having a first polarization direction, are located optically between the light sources 20 and the test areas 30, so that light reaching the test areas 30 from the light source is polarized in the first polarization direction. One or more second polarized light filters 74 having a second polarization direction, are located optically between the test areas 30 and the light detectors 70.

The light filters 72, 74 thus enable the light detectors 70 to receive diffuse, non-specular reflections of the light from the test areas 30 when the sample media is indexed within said holder. The filters 72, 74, however, substantially prevent specular reflections of the light source 20 from reaching the light detectors 70. In addition, in particular embodiments, the light detectors 72, 74 are cross-polarized relative to one another. For example, the detectors 72, 74 may be provided with polarization directions that are substantially orthogonal to one another.

Such cross-polarization helps ensure that any specular reflections (e.g., reflecting off any liquid film on test areas 30) are caught by the second filter 74 even if after passing through the first filter 72. Since specular reflections from the surface of a liquid film tend to maintain their polarization direction, ensuring that the second filter is cross-polarized relative to the first filter, should ensure that most specular reflections are caught by the combination of filters 72, 74, and are prevented from reaching detector 70.

It should be recognized, however, that the polarization directions need not be orthogonal, but rather, may disposed obliquely, in any non-parallel relationship to one another without departing from the scope of the present invention. In addition, in some applications, parallel polarization directions may be used without departing from the scope of the invention. Moreover, although filters are shown and described preferentially as placed optically on both sides of the test areas 30, they may alternatively be placed on only one optical side of the test area(s) 30. Still further, although various embodiments are shown and described, which use only a single filter 72, 74 on each side of test areas 30, it may also be advantageous to use more than one filter on ether side of test areas 30. In this regard, filters may be superposed with one another, with the same or different polarization directions, to enhance the light filtering effects generated thereby.

As also shown, when readhead 12 is optionally incorporated into a photometric diagnostic instrument, a processor 44 may be operatively coupled to detector(s) 70 and light source(s) 20. In particular embodiments, processor 44 is configured to analyze reflectances (colors) captured by the detector(s) 70, to derive a diagnosis value from the analysis, and generate an output corresponding thereto. The output may be fed to a port 46, e.g., for remote display, and/or displayed on an integral display 16.

A method in accordance with embodiments of the invention includes receiving the sample media into a sample holder of a readhead of a photometric diagnostic device, retracting or otherwise positioning the polarized light filters optically between the sample media and a light source, and/or between the sample media and a light detector, respectively. The detectors 70 are then used to capture diffuse, non-specular reflectances of the test areas, while specular reflections of the light source 20 are substantially prevented from reaching the detectors 70. Optionally, the processor 44 may be used to analyze the reflectance(s) and derive the amount of an analyte in the sample therefrom, e.g., to generate an output signal corresponding to the amount.

As is familiar to those skilled in the art, sample media 40 may include typical urine analysis strips, having paper pads disposed in spaced relation thereon, which are soaked in chemical reagents that react with a specimen sample to change color according to the medical condition of the patient, i.e., according to levels of various analytes in the sample. As used herein, the term ‘analyte’ refers to a constituent, or to a property (e.g., pH) of the sample. Examples of such media 40 include the aforementioned MULTISTIX® test strips (e.g., in strip, card, or reel format). Alternatively, sample media 40 may include a conventional immuno-assay cassette, e.g., the CLINITEST® hCG cassette (Siemens), (such as shown schematically in phantom as 40′ in FIG. 3), having chemical reagents that react to the sample to reveal a colored line or pattern of lines according to the medical condition of the patient.

Other suitable sample media may include conventional microfluidic devices (such as shown schematically as 40″ in FIG. 3) which typically include a substrate having a series of narrow channels, e.g. on the order of microns in width, through which a fluid such as blood or urine may travel. The channels conduct the fluid to various test areas on the device. These devices enable various tests to be performed using only a small amount of fluid, e.g., using a small drop of liquid. Exemplary microfluidic devices are described in U.S. patent application Ser. No. 10/082,415 filed on Feb. 26, 2002 and entitled Method and Apparatus For Precise Transfer and Manipulation of Fluids by Centrifugal and or Capillary Forces.

For convenience and clarity, various embodiments of the present invention are described as using sample media 40 in the form of MULTISTIX® test strips, with the understanding that sample media of substantially any form factor, may be used without departing from the scope of the present invention. For example, sample media disposed within relatively large capacity cards or reels of the type used in the above-referenced CLINITEK ATLAS® instrument, may be desired for high volume sample processing. Embodiments of the present invention may also be particularly beneficial when used with alternate media such as microfluidic devices or immuno-assay cassettes due to their often faint or otherwise difficult to read results.

Software associated with the various embodiments of the present invention can be written in any suitable language, such as C++; Visual Basic; Java; VBScript; Jscript; BCMAscript; DHTM1; XML and CGI. Any suitable database technology may be employed, including but not limited to versions of Microsoft Access and IMB AS 400.

Embodiments of the invention are compatible with any of various ways of sampling a reflective surface for its color. For example, measurement of colors may be accomplished by limiting the wavelengths of light which pass to the target. The detector may then be a simple photometer required only to measure the intensity of all light it receives. Among those which commonly use an ordinary photometer or black and white video device as detector are colored LED illumination, illumination from a white source through colored filters, or aperture selection of spectrally distributed light by grating or prism.

Measurement of colors may also be accomplished by limiting the wavelengths of light which pass to the detector after reflection from the surface of the target. For example, illumination may be provided by white light, with colored filters placed in front of the detector. Other approaches include the aperture selection of spectrally distributed light by grating or prism or by use of a color responsive camera, such as an RGB camera. Combinations of these methods or the use of illuminator or detector elements in various arrays may be used with various embodiments of the invention.

Particular embodiments of the present invention will now be described in detail. Turning to FIGS. 1-3, in embodiments of the present invention, a readhead 12 includes a holder 42 (FIGS. 1, 2) having an elongated recess sized and shaped to receive and form an indexed fit with test strip/media 40.

In the embodiment shown, test media 40 includes a reagent strip having a predetermined number of test areas (e.g., reagent pads) 30 thereon. Each reagent pad 30 includes a relatively absorbent material impregnated with a respective reagent, each reagent and reagent pad 30 being associated with a particular test to be performed. When urinalysis tests are performed, they may include, for example, a test for leukocytes in the urine, a test of the pH of the urine, a test for blood in the urine, etc. When each reagent pad 30 comes into contact with a urine sample, the pad changes color, depending on the reagent used and the characteristics of the sample. As discussed above, reagent strip 40 may be a MULTISTIX® reagent strip commercially available from Siemens Healthcare Diagnostics, Inc. The sample media may alternatively include an immuno-assay cassette 40′ or a microfluidic device 40″ as shown in phantom.

One or more light sources 20 are disposed within (e.g., supported by) readhead 12, to emit light onto the test areas 30 when the sample media 40 is indexed within holder 42 and/or the holder 42 is retracted into the instrument 10. Light sources 20 may include substantially any light emitting or coupling device, such as light emitting diodes (LEDs, colored or white), VCSELs, incandescent lamps (e.g., tungsten), fluorescent lamps, cold cathode fluorescent lamps (CCFLs), electroluminescent devices, laser emitting devices such as solid state lasers etc., lightguides, organic LEDs, diode lasers, optical fibers, and/or nominally any other light sources that may be developed in the future. Alternatively, it may even be possible for particular embodiments of the present invention to simply utilize ambient light (e.g., sunlight), e.g., with appropriate light filtering.

In some embodiments, each light source 20 may include an integrated LED package of two or more LEDs of distinct colors. For example, source 20 may include an RGB package of integrated red, green and blue LEDs. The LEDs 20 may be operated in a conventional manner, as discussed hereinbelow, e.g., by selectively emitting monochromatic radiation of mutually distinct wavelengths, such as corresponding to red light, green light and blue light. Alternatively, the RGB LEDs may be operated simultaneously to approximate full spectrum, white light.

A transparent or translucent cover 22, such as fabricated from glass or plastic, may be optionally superposed with sample media 40 and holder 42 to help prevent dirt, debris, splashing, etc., from entering and obscuring light sources 20 or detectors 70.

As discussed above, one or more light or color detectors 70 is also disposed within (or supported by) readhead 12 to detect diffuse reflections from each of the test areas 30. Polarized light filters 72 and 74 are located optically on opposite sides of the test areas 30, i.e., between the light source(s) 20 and the test areas 30, and between the detector(s) 70 and the test areas 30. Filters 72 and 74 are thus configured to substantially prevent specular reflections of the source(s) 20 from reaching detector(s) 70, while allowing diffuse, non-specular reflections to reach the detector(s).

It should be recognized, however, that the angles associated with illumination and reflection may be configured to further avoid specular reflection onto the detectors 70. In the embodiment shown, this may be accomplished by disposing the media 40 (and holder 42) relative to detectors 70 and light sources 20 so that the magnitude of angles of reflectance α, β, etc., of light received by detectors 70, is dissimilar from that of the angles of incidence θ, ω of illumination sources 20 onto reflecting surfaces 52 of test strip 40.

For example, in the embodiment shown in FIG. 3, light source(s) 20 is offset from the media 40, to emit light at an acute angle of incidence θ₁ and θ₂ onto the substantially planar reflecting surface 52 of strip 40. The detector 70, however, is disposed to capture light reflecting from about 60 to 120 degrees from surface 52. This optional configuration thus helps to ensure that detector(s) 70 receives primarily diffuse or scattered reflections from source 20. In some particular exemplary embodiments, the magnitudes of these angles of reflectance α, β, may differ by 5 degrees or more from those of the angles of incidence θ, ω.

It should be recognized that where the sample to be observed has fluid above the solid surface of the media, some position along the curved edge of the fluid tends to assume an angle conducive to reflection of the light source directly toward the detector, a specular reflection. This reflection is reduced or eliminated by embodiments of the present invention.

Moreover, fibrous materials, especially when wet, have surface irregularities which may be visible unaided or only visible with optical magnification. Regardless, portions of the surface may also have angles allowing reflection of the light source directly toward the detector. Such situations of specular reflection are more likely to produce a dulling or fogging of the color image rather than a bright spot or line. This reflection is also reduced or eliminated by embodiments of the invention.

One skilled in the art will recognize that specular reflections (shown at 53 in FIG. 3) are generated, e.g., from wet surfaces, along angles of reflectance that are equal in magnitude to the angles of incidence θ, ω of light thereon. Thus, the use of the polarized (e.g., cross-polarized) filters 72, 74 as described above, with or without the dissimilar angles as described (i.e., illuminating the test strip 40 from a shallow angle relative to the angle of image capture), helps ensure that specular reflections (such as from excess liquid on the strip), are not received by detector(s) 70. These approaches facilitate the elimination of specular reflections without complicated housing geometries configured to attenuate undesired reflections. This construction thus provides for relatively simplified processing, for improved detection simplicity and improved quality through reduction of noise, in the form of specular reflection unresponsive to analyte.

Although the embodiments shown and described herein include angles of incidence that are less than angles of reflection, those skilled in the art should recognize that the opposite may be true, e.g., the angles of incidence may be greater than the angles of reflection, without departing from the spirit and scope of the present invention.

Those skilled in the art should also recognize that the relative positions of the light sources 20 and detectors 70 may be reversed relative to those shown in FIG. 3. For example, detector(s) 70 may be offset in the planar direction relative to pads 30, while light source(s) 20 may be aligned with the pads in the planar direction, without departing from the scope of the present invention.

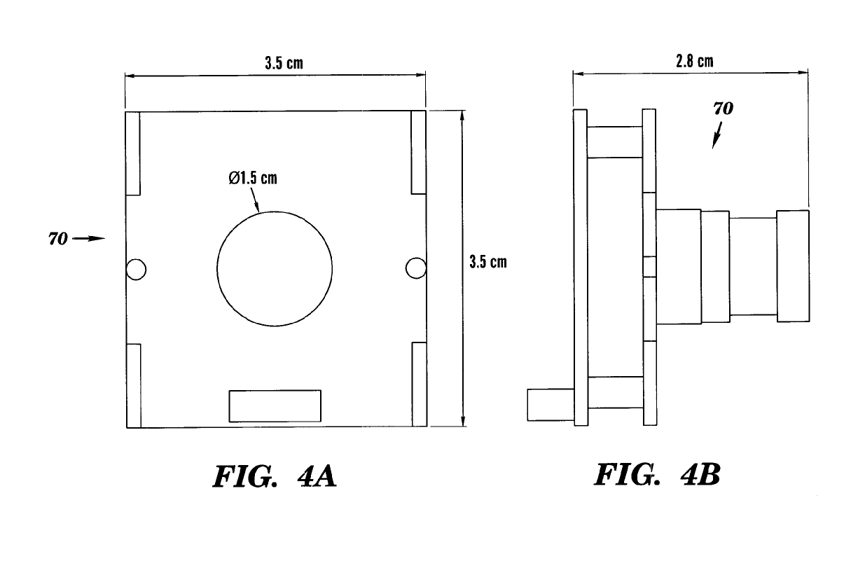

Turning now to FIGS. 4A and 4B, detector 70 may include nominally any conventional light detector, either with or without color filters. In one exemplary embodiment, detector 70 may include a SPC900 detector commercially available from Koninklijke Philips Electronics N.V. The SPC900 device includes filters of three colors (RGB) superposed with an array of individual light sensors. In this embodiment, the RGB LEDs of each light source 20 may be operated simultaneously to illuminate a test area with approximately full spectrum, white light, as discussed hereinabove. The SPC900 has a relatively high resolution, 1.3 megapixels, and employs a sensitive CCD array. This device is also relatively compact, being palm-sized, including circuit boards and lens. As shown, the SPC900 has dimensions of approximately 3.5 cm×3.8 cm×2.8 cm.

Alternatively, a light detector without color filters, such as an array of CMOS or CCD sensors similar to those of the SPC900 device, but without filters, may be used. In such an embodiment, the test areas may be sequentially illuminated with monochromatic light, such as by individual actuation of the red, green and blue LEDs of each light source 20 as discussed above.

As a further alternative, a light detector having color filters may be illuminated monochromatically. For example, a detector 70, such as the SPC900, may be operated in conjunction with sequential illumination by the red, green and blue LEDs of light source 20, to provide enhanced color detection and filtering.

As mentioned above, readhead 12 may be easily incorporated into a variety of photometric diagnostic instruments, such as a CLINITEK® instrument. In such a configuration, readhead 12 may be electrically coupled to the instrument, which would supply power and operate the readhead 12 in a conventional manner, as will be described hereinbelow.

Alternatively, readhead 12 may be provided with additional components, as shown in phantom in FIG. 3, including for example, one or more of a processor 44, memory 47, an output port 46, integral display 48, and a power supply (e.g., battery) 49. These additional components 44, 46, 48, 49 may be integrated into housing 12, to form a unitary photometric diagnostic instrument. Alternatively, one or more of these components may be associated with other devices (e.g., a CLINITEK® instrument), which may be communicably coupled, such as via a network, thereto.

In operation of various embodiments, a light source(s) (e.g., LED) 20 is actuated, to illuminate reagent strip 40. Detector 70 then receives enough reflected light from the reagent strip 40 to determine the color thereof. Detector(s) 70 may sense light from a particular location on reagent media 40, 40′, 40″. Alternatively, in some embodiments, a plurality of LEDs 20 may be illuminated to provide greater illumination. Although a plurality of lights 20 and detectors 70 may be used, the aforementioned use of filters enables as few as a single detector 70 to be provided with a sufficiently large field of view (e.g., by being spaced sufficiently far from media 40) so as to capture multiple test areas 30 within a single image. This bulk image capture may be particularly desirable when used with relatively large analyzers, which are typically automated and capable of handling relatively large numbers of test samples. These multiple test areas within a single image, may be disposed on one or more test strips or other sample media types (such as the aforementioned cards, reels, etc.). In this regard, it should be understood that these multiple test areas may be disposed in test sets of substantially any geometric pattern, including both linear arrays (such as provided by strips 40), and two-dimensional arrays (such as may be disposed on the aforementioned cards or reels, or as may be provided by placing multiple strips 40, cassettes 40′, or microfluidic devices 40″, side-by-side with one another).

Referring now to Table I, particular aspects of exemplary operation will be described in greater detail. As shown, a conventional or simplified operating system (OS) of the CLINITEK® instrument running in the host instrument or in processor 44, may be used to ensure media 40, 40′, 40″ is properly positioned 78 between filters 72, 74. For example, the processor 44 may retract holder 42 into the instrument 10, or otherwise ensure proper positioning of various media 40, 40′, 40″, optically between source 20, detector 70, and filters 72, 74. The light source 20 may be actuated at 80 to illuminate media 40, 40′, 40″. Detector 70 may also be actuated 82 to detect the color of light reflected from the media, and optionally store 84 the color information to memory 47. The OS may actuate 86 the processor in a conventional manner to analyze the color information, such as by comparing the captured color information to a database of known color-coded diagnostic values. Steps 78-86 may be repeated for additional test media.

TABLE I

| | |
|---|---|
| 78 | Position media between filters |
| 80 | Actuate light source |
| 82 | Detect color of reflected light |
| 84 | Optionally store the color information to memory |
| 86 | Analyze color information |
| 88 | Repeat steps 80-86 for additional test areas |

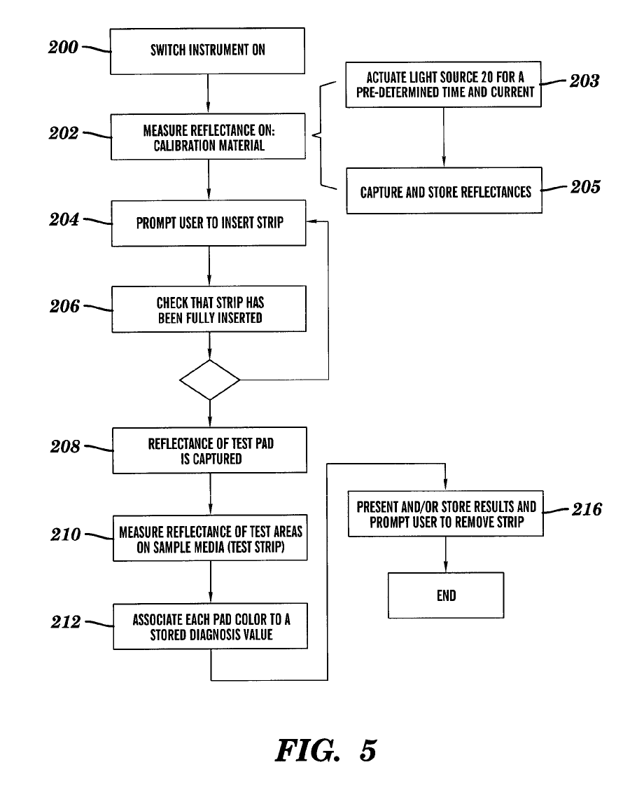

Additional operational aspects are substantially similar to those of conventional photometric diagnostic instruments such as the above-referenced CLINITEK® instrument, and/or as described in the above referenced '634 application. Such operational aspects are briefly described with respect to FIGS. 5 & 6.

Turning to FIG. 5, the instrument, including readhead 12 is initially powered up at 200, after which reflectance of calibration material is measured at 202. Calibration 202 may be effected automatically, e.g., each time the instrument is powered up 200, or may be initiated by the user who inserts a calibration material, for example, in response to an audible or visual prompt.

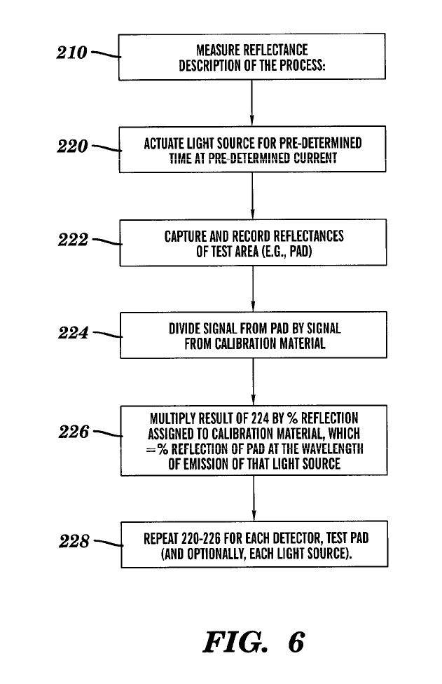

Calibration 202 includes actuating or otherwise exposing the calibration material to light source(s) 20 for a pre-determined time and pre-determined current (e.g., when using an electrically actuated source 20) at 203, and capturing and storing reflectances of the calibration material (e.g., per Table I above) at 205. These calibration reflectances are used to effect sample measurement 210 as discussed in detail below with respect to FIG. 6.

Once calibration is complete, the instrument may prompt the user to insert sample media 40, 40′, 40″ at step 204. Upon insertion, at 206, the system checks for an appropriate signal, e.g., from one or more of detectors 70, (or alternatively from nominally any other electromechanical switch, actuator, etc.) indicating that sample 40 has been fully inserted/positioned between filters 72, 74. If this signal has not been received, then the system loops back to step 204 to re-prompt the user to fully insert/position the sample. If the signal was received, then reflectance is captured 208 and measured 210 (described in greater detail below with respect to FIG. 6), and compared to calibration values generated during calibration 202.

At 212, these reflectance values (colors) are compared to known diagnosis values stored in memory (e.g., 47). At 216, results (i.e., diagnosis values) generated by step 212 are then outputted to a display (e.g., 16) and/or stored to memory, and the user prompted to remove the strip.

Turning now to FIG. 6, measurement 210 is discussed in greater detail. As shown, this measurement includes actuating light source 20 for a pre-determined time and pre-determined current (e.g., for electrically actuated light sources) at 220. This pre-determined time and current is preferably the same as that used during steps 203 and 205 of the calibration discussed above.

The steps of Table I are effected relative to sample media 40, 40′, 40″ etc., and signals received (i.e., reflectances captured) by detectors 70 are saved to memory at 222. At 224, a numerical value of the captured reflectance is divided by a numerical equivalent of the reflectance value of the calibration material acquired at step 205 above. At 226, the result of 224 is multiplied by the known percent reflection of the calibration material to generate the percent reflection of the particular pad or portion of sample 40, etc., at the known wavelength of emission of the particular light source 20. This percent reflection, used alone or in combination with additional percent reflectances determined using light sources of various discrete wavelengths as discussed below, corresponds to a color that may be correlated to known diagnosis values as discussed above.

As shown at 228, steps 220-226 may be repeated for each portion of interest of the sample media (e.g., each test pad and each detector), and optionally, for each of a plurality of light sources, e.g., in the event light sources of distinct wavelengths (e.g., colors) are used individually. In this regard, individual red, green and blue LEDs of an LED package 20 may be actuated simultaneously for an approximation of full spectrum white light as mentioned above. Alternatively, the RGB LEDs may be actuated individually to obtain percent reflectances at multiple discrete wavelengths. Percent reflectances may be obtained at any, or each, of the three wavelengths (e.g. RGB). In many instances, it may be desirable to use individual percent reflectances obtained using all three wavelengths to infer the color of the pad.

In other instances, such as when it is expected that a reflectance will be within a particular range (e.g., blue-green), the actual color may be inferred using fewer (e.g., two, or even one) discrete wavelengths.

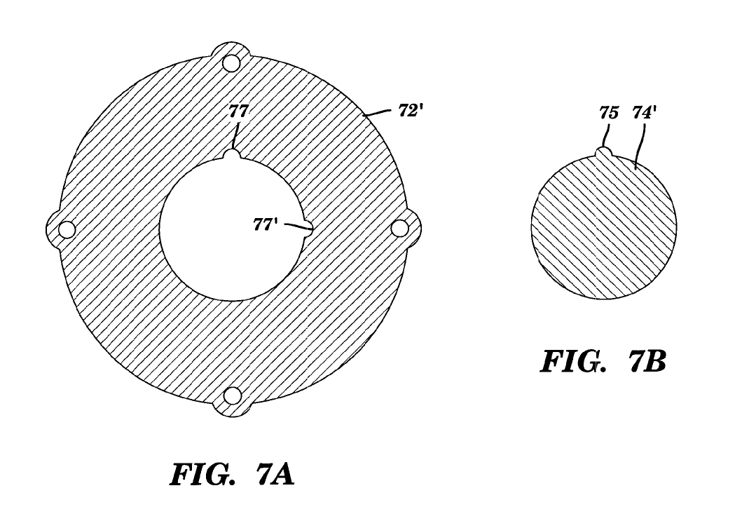

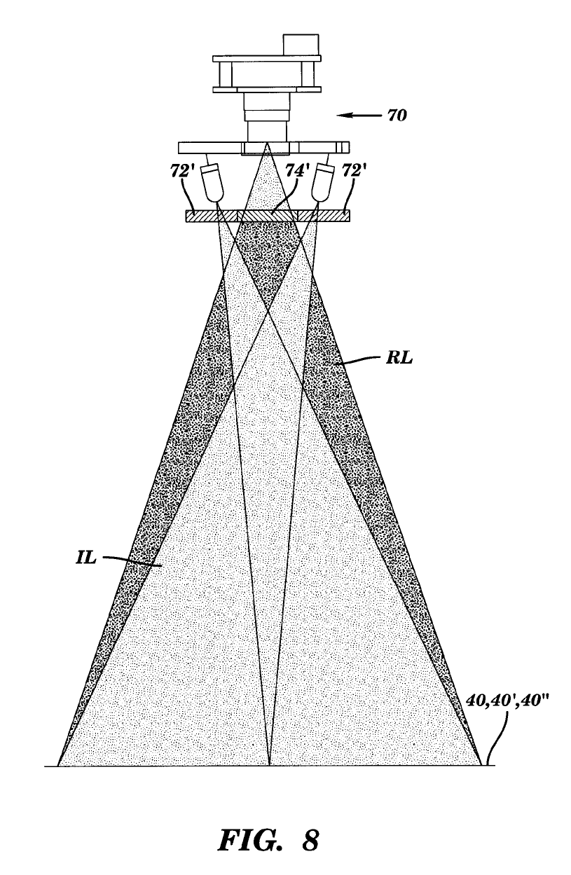

Turning now to FIGS. 7A, 7B and 8, an alternate embodiment of the present invention is shown and described.

As shown in FIGS. 7A, 7B, exemplary filters 72′, 74′ are cut from polarizer material, such as item #45668 from Edmund Industrial Optics (Barrington, N.J.). As shown, filter 74′ is sized and shaped for receipt within a similarly sized and shaped recess within filter 72′. The polarization direction of filter 74′ (shown by cross-hatching in FIG. 7B) may be oriented at substantially any direction relative to that of filter 72′. In the example shown, filter 74′ includes a detent 75 that fits within a similarly sized and shaped recess 77 of filter 72′ to maintain filter 74′ at a polarization direction that is substantially orthogonal to that of filter 72′. Alternatively, detent 75 may be placed within recess 77′ to maintain substantially parallel polarization directions between filters 72′ and 74′. It should be recognized that recesses 77, 77′, etc., may be placed substantially anywhere along the inner circumference of filter 72′ to permit the polarization direction of filter 74′ to be maintained at substantially any orientation to the polarization direction of filter 72′.

As shown in FIG. 8, source light from light sources 20 passes through polarization filter 72′ to illuminate the sample media 40, 40′, 40″ with illumination light (IL) of a particular polarization. Light reflected from the sample media (reflected light, RL), typically includes both specular reflection of the same polarization as IL, plus light with polarization which has become randomized after interrogating the target surface and regions below its surface, as discussed hereinabove. This reflected light, RL, passes through filter 74′, to exclude the portion of the RL having the same polarization as IL, e.g., to help minimize specular reflections on detector 70.

Optionally, the angles associated with illumination and reflection may be configured to further avoid specular reflection onto the detectors 70, such as shown and described hereinabove with respect to the embodiment of FIGS. 1-4.

The following illustrative example is intended to demonstrate certain aspects of the present invention. It is to be understood that this example should not be construed as limiting.

### Example

A readhead 12 was fabricated substantially as shown and described hereinabove with respect to FIGS. 1-4. Sample media substantially similar to a MULTISTIX® (Siemens) test strip 40 was tested with a broad range of analytes, using cross-polarized filters 72, 74 as shown. These test results were compared with the results of similar testing using parallel filters, and with results of similar testing on a commercial instrument which does not use polarization filters 72, 74. The commercial instrument used an optical read head described in U.S. Pat. Nos. 5,661,563 and 6,180,409. As shown in the following Table 11, the cross-polarized filters 72, 74 provided reflectances having a predominantly higher signal to noise ratio (S/N) than either of the other two configurations.

As shown in Table II, data from the perpendicular and parallel arrangements of polarization filters serve to compare the effect of orientations on reduction of specular reflections. It is understood that specular reflections tend to not only contribute to increased standard deviation (SD) of the data but also decrease the proportion of light which represents interrogation of the analyte responsive dye system within the diagnostic medium. While specular reflections are noise factors, being an unwanted contributor to the received light, they also tend to adversely affect the signal in an analytical system, e.g., by obscuring the difference in response to different levels of analyte.

TABLE II

| | | | Conventional | | | Cross Polarized | | | Parallel Polarized | | |
|---|---|---|---|---|---|---|---|---|---|---|---|
| | | | No Polarization Filters | | | Perpendicular Polarizations | | | Parallel Polarizations | | |
| | | | Conventional Optics | | | 2 D Array Optics | | | 2 D Array Optics | | |
| | | | Commercial Instrument | | | Prototype Instrument | | | Prototype Instrument | | |
| Analyte | | | | Noise | | | Noise | | | Noise | |
| Analyte | Conc. | | Signal Mean | SD | S/N | Signal Mean | SD | S/N | Signal Mean | SD | S/N |
| Bilirubin | 0 | mg/dL | 1037 | 8.0 | — | 183 | 1.5 | — | 156 | 3.1 | — |
| Bilirubin | 0.8 | mg/dL | 914 | 8.0 | 15 | 162 | 1.8 | 13 | 139 | 2.1 | 6 |
| Glucose | 0 | mg/dL | 740 | 11.0 | — | 161 | 4.9 | — | 165 | 2.1 | — |
| Glucose | 0.1 | mg/dL | 557 | 22.0 | 11 | 121 | 1.4 | 11 | 122 | 1.0 | 27 |
| Glucose | 0.25 | mg/dL | 409 | 35.0 | 5 | 112 | 2.0 | 5 | 116 | 1.6 | 5 |
| Glucose | 1 | mg/dL | 133 | 20.0 | 10 | 94 | 1.3 | 11 | 103 | 1.2 | 9 |
| Ketone | 0 | mg/dL | 724 | 16.0 | — | 162 | 1.4 | — | 163 | 1.6 | — |
| Ketone | 10 | mg/dL | 387 | 27.0 | 15 | 124 | 1.0 | 31 | 134 | 1.8 | 17 |
| Leukocyte | 0 | cells/uL | 0 | 0.0 | — | 175 | 1.8 | — | 177 | 2.6 | — |
| Leukocyte | 42 | cells/uL | 242 | 36.0 | 10 | 152 | 0.8 | 17 | 153 | 3.1 | 8 |
| Nitrite | 0 | mg/dL | 926 | 7.0 | — | 193 | 1.4 | — | 192 | 2.5 | — |
| Nitrite | 0.15 | mg/dL | 768 | 7.0 | 23 | 183 | 2.5 | 5 | 179 | 1.8 | 6 |
| pH | 6 | | 2089 | 142.0 | — | 178 | 1.0 | — | 182 | 1.4 | — |
| pH | 7 | | 870 | 98.0 | 10 | 136 | 1.9 | 27 | 154 | 3.9 | 10 |
| pH | 8 | | 349 | 70.0 | 6 | 100 | 1.6 | 20 | 138 | 2.2 | 5 |
| Protein | 0 | mg/dL | 938 | 9.0 | — | 188 | 1.4 | — | 188 | 2.6 | — |
| Protein | 30 | mg/dL | 638 | 16.0 | 23 | 156 | 1.2 | 25 | 162 | 1.5 | 12 |
| Urobilinogen | 1 | mg/dL | 647 | 20.0 | — | 148 | 2.1 | — | 150 | 2.0 | — |
| Urobilinogen | 4 | mg/dL | 504 | 26.0 | 6 | 139 | 3.2 | 3 | 142 | 3.9 | 3 |
| Albumin | 0 | mg/L | 1723 | 14.0 | — | 186 | 1.3 | — | 196 | 1.9 | — |
| Albumin | 30 | mg/L | 1450 | 23.0 | 14 | 149 | 0.8 | 34 | 174 | 2.0 | 11 |
| Albumin | 150 | mg/L | 944 | 24.0 | 22 | 98 | 2.7 | 25 | 146 | 2.1 | 14 |
| Creatinine | 50 | mg/dL | 445 | 15.0 | — | 151 | 1.7 | — | 157 | 1.6 | — |
| Creatinine | 200 | mg/dL | 190 | 19.0 | 15 | 95 | 1.8 | 32 | 112 | 1.6 | 28 |
| Average S/N: | | | | | 13 | | | 19 | | | 11 |

S/N = Signal/Noise = ΔSignal Means/RMS-SD

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense. It is also to be recognized that aspects associated with a particular embodiment disclosed herein may be used in connection with any other embodiment disclosed herein, without departing from the scope of the present invention.

Having thus described the invention, what is claimed is:

1. A readhead for a photometric diagnostic instrument for illuminating a target area and detecting color information from the target area, the readhead comprising:
one or more light sources configured to emit light towards test areas disposed in spaced relation on a reagent sample media, each of the test areas configured to react with a sample when disposed in contact with the sample and to change color according to an amount of an analyte in the sample;
one or more light detectors disposed to receive light reflected from the test areas;
one or more polarized light filters disposed optically between the test areas and at least one of the light sources and the detectors;
said polarized light filters configured to substantially filter specular reflections of the light while enabling diffuse non-specular reflections to reach the test areas.

2. The readhead of claim 1, comprising one or more other polarized light filters disposed optically between the test areas and the other of the light sources and the detectors, said other polarized light filters having a polarization direction distinct from that of the polarized light filters.

3. The readhead of claim 2, wherein the polarized light filters and the other polarized light filters are cross-polarized relative to one another, so that light reaching the test areas from the light sources is polarized in the polarization direction, and light reaching the detectors from the test areas is polarized in the other polarization direction.

4. The readhead of claim 1, wherein said first and second polarization directions are optically orthogonal to one another.

5. The readhead of claim 1, comprising a holder configured for receiving the reagent sample media therein.

6. The readhead of claim 5, wherein the holder is sized and shaped for forming an indexed fit with the sample media.

7. The readhead of claim 1, wherein said light detectors comprise color detectors.

8. The readhead of claim 1, wherein said first and second polarized light filters are configured to substantially prevent said light detectors from receiving specular reflections of the light from the test areas.

9. The readhead of claim 1, being adapted for incorporation within the photometric diagnostic instrument.

10. The readhead of claim 1, wherein:
the test areas have substantially planar reflecting surfaces defining a planar direction;
said light sources configured to emit light onto the test areas at a predetermined angle of incidence relative to the planar direction;
said light detectors each configured to receive reflections emanating from the test areas at predetermined angles of reflectance relative to the planar direction; and
magnitudes of said angles of incidence and said angles of reflection being distinct from one another.

11. The readhead of claim 10, wherein the magnitudes of said angles of incidence and said angles of reflection are sufficiently distinct so that the specular reflections land at least one mm away from the light detectors.

12. The readhead of claim 11, wherein the angles of incidence are substantially oblique to the planar direction and said angles of reflectance are normal to the planar direction.

13. The readhead of claim 1, wherein the test areas have substantially planar reflecting surfaces defining a planar direction, said one or more detectors is offset in the planar direction from said light sources.

14. The readhead of claim 1, wherein said light detectors are configured to receive diffuse, non-specular reflections of the light associated with a range of distinct analytes.

15. The readhead of claim 1, wherein the one or more light sources comprises an array of devices selected from the group consisting of light emitting diodes (LEDs), VCSELs, tungsten lamps, lightguides, organic LEDs, diode lasers, sunlight, ambient light, or optical fibers.

16. The readhead of claim 15, wherein the one or more light sources comprises an array of RGB LEDs.

17. The readhead of claim 1, wherein the one or more light detectors comprises one or more CMOS devices.

18. The readhead of claim 1, wherein the one or more light detectors comprises one or more CCD devices.

19. The readhead of claim 10, comprising a memory device operatively engaged with said light detectors.

20. A photometric diagnostic instrument comprising:
the readhead of claim 1;
a processor operatively coupled to said light or color detectors and to said light sources;
said processor configured to analyze the reflections received by said light or color detectors; and
said processor configured to derive a diagnosis value from said analysis, and to generate an output corresponding thereto.

21. The instrument of claim 20, wherein said light detectors are configured to receive diffuse, non-specular reflections of the light, said reflections being associated with a range of distinct analytes.

22. The instrument of claim 20, comprising a memory device coupled to said light or color detector.

23. The instrument of claim 22, wherein said memory device is configured for storing diagnostic data.

24. The instrument of claim 23, wherein said memory device is configured for storing calibration data.

25. The instrument of claim 22, wherein said memory device is configured to store the reflections received by said light or color detectors.

26. The instrument of claim 20, wherein said diagnosis value comprises the amount of said analyte.

27. The instrument of claim 20, wherein said diagnosis value comprises a diagnosis of a condition.

28. The instrument of claim 20, wherein said light or color detector comprises a CMOS device.

29. The instrument of claim 20, wherein said light or color detector comprises a CCD device.

30. The instrument of claim 20, wherein said sample media includes a test strip, and said test areas include test pads.

31. The instrument of claim 20, wherein said sample media comprises an immuno-assay cassette.

32. The instrument of claim 20, wherein said sample media comprises a microfluidic device.

33. A method for reading reagent sample media, the sample media having a plurality of test areas disposed in spaced relation thereon, each of the test areas configured to react with a sample when disposed in contact with the sample and to change color according to an amount of an analyte in the sample, the method comprising:
(a) receiving the sample media into a readhead of a photometric diagnostic device;
(b) disposing one or more polarized light filters optically between the sample media and at least one of a light source and a light detector;
(c) emitting light onto the test areas;
(d) capturing diffuse, non-specular reflectances of the test areas with one or more light or color detectors;
(e) determining the color of the non-specular reflectances;
(f) deriving the amount of an analyte in the sample from said determining (e); and
(g) generating an output signal corresponding to the amount.

34. The method of claim 33, wherein said disposing (b) comprises disposing polarized light filters optically between the sample media and the light source, and between the sample media and the light detector.

35. The method of claim 34, wherein said disposing (b) further comprises disposing cross-polarizing the polarized light filters.

36. The method of claim 33, wherein the sample media is selected from the group consisting of test strips, immuno-assay cassettes, and microfluidic devices.

37. The method of claim 33, further comprising the step of calibrating the light or color detectors.

38. The method of claim 37, wherein said calibrating comprises effecting steps (a)-(e) for a calibration material of known color reflectance.

39. The method of claim 38, wherein said deriving (f) comprises:
dividing the reflectance of the test pad by the reflectance of the calibration material; and
multiplying the result of said dividing by the known reflectance of the calibration material to generate a calibrated percent reflectance of the test pad.

40. The method of claim 39, wherein said deriving (f) further comprises comparing the calibrated percent reflectance with known values of amounts of said analyte at various predetermined percent reflectances, to determine the amount of said analyte at said calibrated percent reflectance.

41. A readhead for a photometric diagnostic instrument for illuminating a target area and receiving light from the target area, said readhead comprising:
holding means for receiving reagent sample media therein, the sample media having a plurality of test areas disposed in spaced relation thereon, each of the test areas configured to react with a sample when disposed in contact with the sample and to change color according to an amount of an analyte in the sample;
illumination means configured for emitting light towards the test areas;
first filter means for polarizing light passing therethrough in a first polarization direction;
said first filter means disposed optically between the illumination means and the test areas, wherein light reaching the test areas from the illumination means is polarized in the first polarization direction;
color detection means for detecting a color of the test areas;
second filter means for polarizing light passing therethrough in a second polarization direction;
said second filter means disposed optically between the test areas and the illumination means;
said first and second filter means configured to enable said detection means to receive diffuse, non-specular reflections of the light from the test areas when the sample media is indexed within said holding means; and
said first and second filter means configured to substantially prevent said color detection means from receiving specular reflections of the light.

42. A photometric diagnostic instrument comprising:
the readhead of claim 41;
processing means operatively coupled to said color detection means and to said illumination means;
said processing means configured to analyze the reflections received by said color detection means; and
said processing means configured to derive a diagnosis value from said analysis, and to generate an output corresponding thereto.
